(19) United States
(12) Patent Application Publication
(10) Pub. No.: US 2008/0037813 A1
(43) Pub. Date: Feb. 14, 2008

(54) Carrying case with integrated speaker system and portable media player control window

(76) Inventor: Jason Entner, Brooklyn, NY (US)

Correspondence Address: Gary J. Gershik;Cooper & Dunham, LLP, 1185 Avenue of the Americas, New York, NY, 10036, US

(21) Appl. No.: 11/500,650

(22) Filed: Aug. 8, 2006

(51) Int. Cl. H04R 9/06; H04R 1/02

(52) U.S. Cl. 381/333; 381/334; 381/388

(57) ABSTRACT

A bag or luggage for portable media players includes an amplifier contained within the bag or luggage. The amplifier amplifies an audio signal from a portable media player. One or more speakers contained within the bag or luggage are connected to the amplifier. The speakers reproduce sound from the amplified audio signal. An enclosure houses the personal media player. A front portion of the enclosure is made of a soft transparent layer suitable for viewing and controlling the personal media player.

### BACKGROUND

1. Technical Field

The present disclosure relates to a carrying case and, more specifically, to a carrying case with an integrated speaker system and a portable audio player control window.

2. Description of the Related Art

Portable media players (PMPs) are personal electronic devices that may be used to electronically reproduce media such as audio, still pictures, and/or motion video. Legacy PMP devices include portable cassette players, portable radios, and portable CD players. Other PMP devices include CD players, MiniDisc players, DVD players, portable televisions, portable satellite radios, digital music players such as MP3 players, and portable video players. Many of today's PMPs include memory storage for storing digital content without the need for swapping cassettes or discs. Digital storage may be provided by a miniature hard disk drive and/or solid-state flash memory.

While many PMPs have available remote controls, PMPs are generally controlled by pressing buttons located on the face of the device. While such controls are convenient for users who prefer to hold their device in their hand, many users prefer to keep their hands free when using their device, some users preferring to keep their devices in a pocket, carrying case or bag. However, because both the controls and LCD screen tend to be located on the face of the device, using a PMP while contained in a case or bag compromises the user's ability to control the device and view the screen.

Modern PMPs are often very expensive and can be quite fragile, especially where digital storage is based on a miniature hard disk drive. PMPs may also be easily scratched or otherwise damaged if left unprotected.

Moreover, PMPs often lack internal speakers, only allowing users to hear reproduced audio through headphones or by carrying around bulky external speakers.

### SUMMARY

It is therefore desirable to utilize a carrying case such as a bag or luggage that has the ability to hold, among other items, a PMP or similar electronic device, safely and securely. It is also desirable for the carrying case to provide access to the face of the PMP so that controls may be utilized and an LCD screen seen. It is also desirable for the carrying case to provide integrated speakers.

A bag or luggage for portable media players includes an amplifier contained within the bag or luggage. The amplifier amplifies an audio signal from a portable media player. One or more speakers contained within the bag or luggage are connected to the amplifier. The speakers reproduce sound from the amplified audio signal. An enclosure houses the personal media player. A front portion of the enclosure is made of a soft transparent layer suitable for viewing and controlling the personal media player.

### BRIEF DESCRIPTION OF THE DRAWINGS

A more complete appreciation of the present disclosure and many of the attendant advantages thereof will be readily obtained as the same becomes better understood by reference to the following detailed description when considered in connection with the accompanying drawings, wherein:

FIG. 1 shows an outside view of a folio-style case according to an embodiment of the present invention with an open flap;

FIG. 2 shows an outside view of the folio-style case shown in FIG. 1 with, a closed flap;

FIG. 3 shows an inside view of the folio-style case shown in FIGS. 1 and 2;

FIG. 4 shows a messenger bag according to an embodiment of the present invention;

FIGS. 5A-5C show the external portable media player enclosure shown in FIG. 4; and

FIG. 6 shows a messenger bag according to another embodiment of the present disclosure.

### DETAILED DESCRIPTION

In describing the preferred embodiments of the present disclosure illustrated in the drawings, specific terminology is employed for sake of clarity. However, the present disclosure is not intended to be limited to the specific terminology so selected, and it is to be understood that each specific element includes all technical equivalents which operate in a similar manner.

Embodiments of the present invention provide for a protective carrying case for a PMP that may be capable of securely and safely storing a PMP while allowing for access to the face of the PMP so that controls may be utilized and an LCD screen may be viewed. The case additionally comprises external speakers that may be mounted on the front of the case or hidden from view. Embodiments of the present invention may additionally include a PMP dock for interfacing the PMP with the present invention. The dock may comprise an audio-in connector, a power cable, and/or any other form of connector that may be used to interface the PMP.

Embodiments of the present invention may be built around any type of carrying case, luggage or bag. For example, the case may be a folio-style case, a messenger bag, a backpack, a suitcase, a handbag, a purse, or any other form of handbag or luggage.

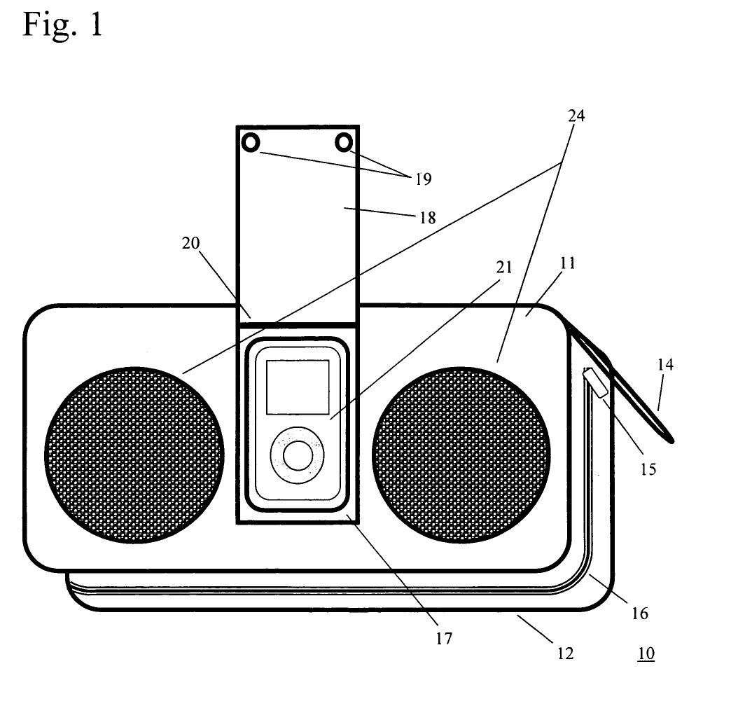

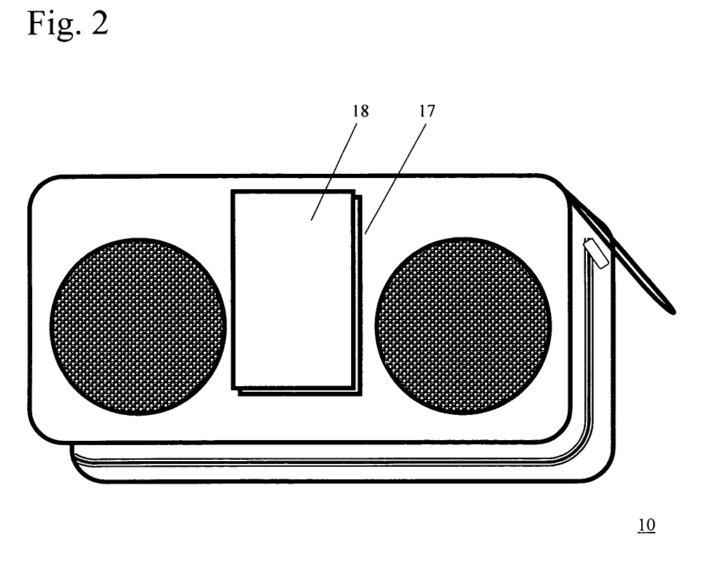

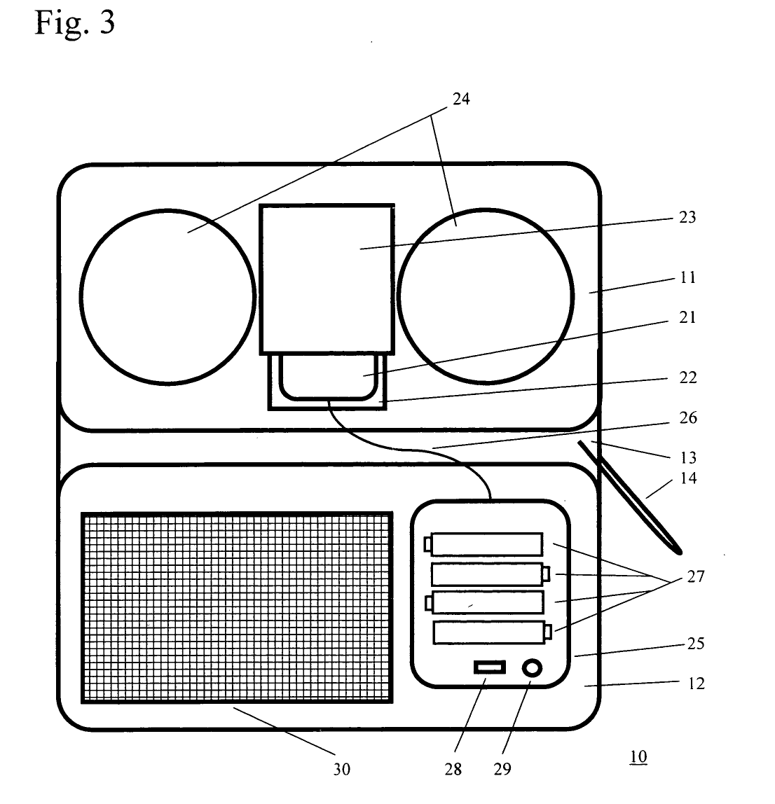

FIGS. 1-3 show a folio-style case according to an embodiment of the present invention. The folio-style case 10 may be a case having a top section 11 and a bottom section 12 with a connecting hinge section 13 there between. The case 10 may be closed as shown in FIGS. 1 and 2 or opened as shown in FIG. 3. When closed, the case 10 may be easily transported, for example by a carrying strap 14. The top section 11 and the bottom section 12 may be joined together, for example, using a zipper 15 and teeth 16.

A PMP access port bezel 17 may be provided on the top section of the case. The PMP access port bezel 17 may be covered by a cover flap 18 so that the PMP 21 may be made accessible when the cover flap 18 is opened (as seen in FIG. 1) or the PMP 21 may be protected when the cover flap 18 is closed (as seen in FIG. 2). The cover flap 18 may be hingedly connected to the PMP access port bezel 17 by a hinge 20. Alternatively, the cover flap 18 may be retractable or removable. The cover flap 18 may be secured to the PMP access port bezel 17 by a fastening means, for example, by magnets 19 within the cover flap 18. The magnets 19 may attract a magnetic or metallic section of the PMP access port bezel 17 when closed. Alternatively, other securing means such as snaps, clips, zippers, Velcro or the like may be used to hold the cover flap 18 in the closed position.

When the cover flap 18 is in the open position as shown in FIG. 1, the PMP 21 is accessible. The PMP 21 may be held in place and protected by a soft and transparent layer 22, for example, made of plastic. The transparent plastic layer 22 may allow for the PMP 21 to be viewed and controlled through the plastic layer 22. For example, an LCD screen may be viewed and controls manipulated. The transparent plastic layer 22 protects the PMP 21 from physical damage such as scratching.

The PMP 21 may be held in place from the inside of the case 10 by a securing pocket 23, the face of the securing pocket 23 being the transparent plastic layer 22 and the PMP access port bezel 17. The securing pocket 23 may allow for the PMP 21 to be inserted within it such that the PMP 21 may be held in place and remain accessible through the transparent plastic layer 22 even when the case 10 is transported.

One or more speakers 24 may be mounted on the top section 11 of the case 10. The front of the speakers 24 may show through the top section 11. Alternatively, the top section 11 may be sound-permeable and the front of the speakers may remain hidden from view by the top section 11. For example, the top section 11 may have a porous outer coating and the speakers 24 may be placed beneath the outer porous or otherwise sound transmitting covering.

The PMP 21 may be connected to an amplifier 25 that is mounted within the case 10, for example, by an audio connector 26. The amplifier 25 may be powered by a portable power source such as one or more batteries 27. The batteries 27 may be rechargeable and/or single-use batteries. Alternatively, the portable power source may be a fuel cell, solar panel, hand crank or any other suitable power source. According to one embodiment of the present invention, the PMP 21 may also be connected to the amplifier 25 by a power cord (not shown) to allow the PMP to be powered by the batteries 27. According to another embodiment of the present invention, the PMP 21 is powered from its internal power source and does not receive power from the amplifier batteries 27. According to still another embodiment of the present invention, the PMP 21 is powered from a second set of batteries (not shown). The amplifier may have a set of controls 28 that may control the function of the amplifier. According to one embodiment of the present invention, the amplifier controls 28 are mounted on the amplifier 25 and thus only accessible when the case is open (as seen in FIG. 3). According to another embodiment of the present invention, the amplifier controls 28 are mounted on the top section 11 of the case 10 so that they are accessible even when the case 10 is closed.

The amplifier controls 28 may include such controls as an on-off switch and a volume control. The amplifier 25 may also include a power port 29 for receiving power without having to use the batteries 27.

An accessory pouch 30 may be provided within the case for holding related accessories such as, for example, headphones, media cards, and other such accessories. The case 10 may also be large enough to encompass various other sections and/or compartments so that other items, for example, items not related to the PMP 21 may be enclosed.

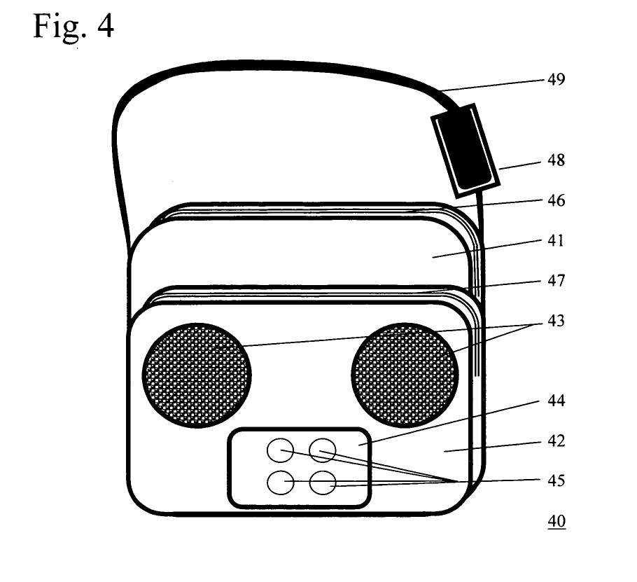

Embodiments of the present invention may be built around a messenger bag. FIG. 4 shows a messenger bag according to an embodiment of the present invention. The messenger bag 40 may have multiple compartments, for example a primary compartment 41 and a secondary compartment 42. The messenger bag 40 may also have additional compartments (not shown). One or more compartments may be used to house PMP related accessories.

Each compartment may be secured using a securing means such as snaps, zippers, Velcro or the like. In the messenger bag of FIG. 4 zippers 46 and 47 may be used to secure the primary compartment 41 and secondary compartment 42 respectively.

A compartment, for example, the secondary compartment 42 in FIG. 4, may house an amplifier and speakers 43. The amplifier may be located entirely within the compartment 42 and thus hidden from view. The amplifier may have a control panel 44 that may be mounted on the front of the messenger bag 40. The control panel 44 may comprise one or more controls 45. The controls 45 may control such functions as power, volume and sound enhancement controls. The amplifier may be powered and may contain one or more batteries that may be rechargeable and/or single-use.

The amplifier may be connected to a PMP by an audio and/or power cord as described in the example above. However, in the example shown in FIG. 4, the PMP may be housed within an external PMP enclosure 48. The PMP enclosure 48 may be attached to a shoulder strap 49 as shown in FIG. 4 or may be integrated into the messenger bag 40.

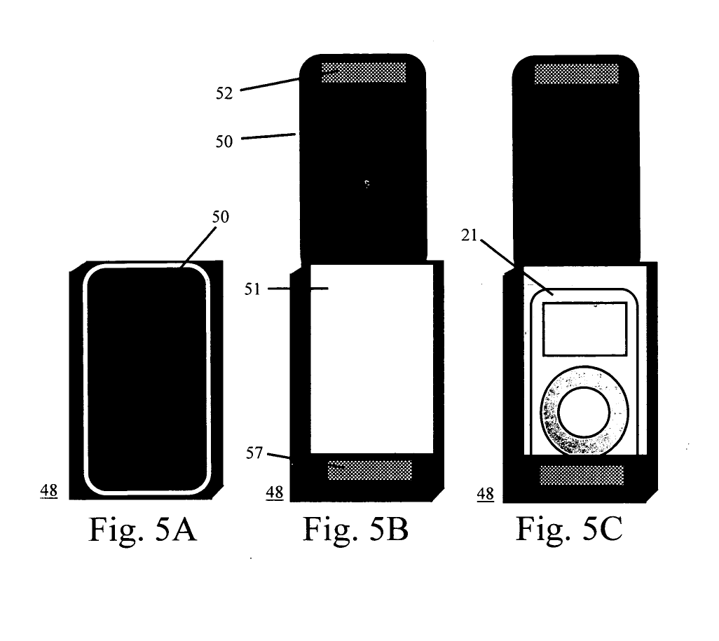

FIGS. 5A-5C show close-up diagrams of the PMP enclosure shown in FIG. 4. The PMP enclosure 48 may have a protective cover flap 50 which may be in the closed position as seen in FIG. 5A or in the open position as seen in FIGS. 5B and 5C. When closed, the flap 50 provides additional protection for the PMP 21. When opened, the PMP may be viewed and controlled.

FIG. 5B shows the PMP enclosure 48 without the PMP 21 inserted therein while FIG. 5C shows the PMP enclosure 48 with the PMP 21 inserted therein.

Even when the flap 50 is in the open position, the PMP 21 remains protected behind a soft and transparent layer 51, for example made of plastic. The flap 50 may be secured in the closed position by a securing means such as snaps, zippers, Velcro or the like. In FIGS. 5B and 5C, a top Velcro strip 52 mounted on the inside of the flap 50 connects with a bottom Velcro strip 57 mounted on the enclosure 48 to secure the flap 50.

According to one embodiment of the present invention, the audio wire that connects the amplifier to the PMP may travel discretely along or within the shoulder strap 49. However, wireless technology may be used to transmit audio from the PMP to the amplifier.

While embodiments of the present invention may utilize any variety of bag or luggage, many features are shared by multiple embodiments. For example, many embodiments utilize a PMP compartment, enclosure or pocket protected on its face by a transparent plastic layer. This feature allows for the PMP to remain simultaneously protected, accessible, and viewable. Many embodiments utilize amplifier controls that are accessible on the front of the bag or luggage. Many embodiments also utilize speakers that are attached thereto. The novel combination of these features provides for a portable audio carrying solution that provides a high degree of protection, allows for direct PMP view and control, and provides built-in amplified speakers.

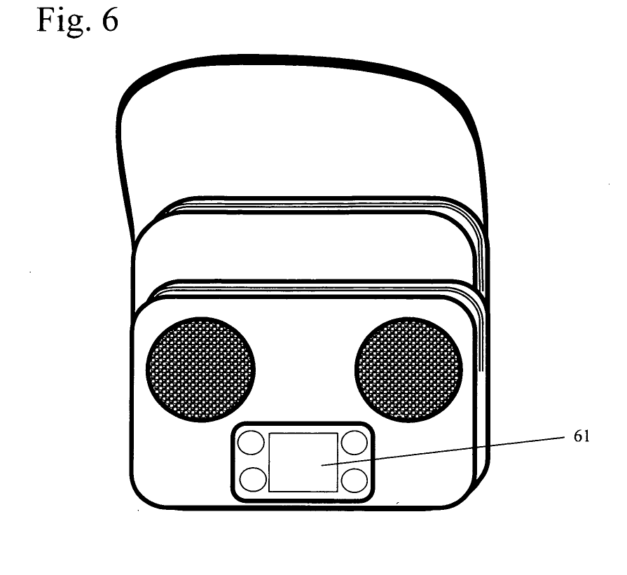

According to an alternative embodiment of the present invention, the bag or luggage may include a display screen. FIG. 6 is a diagram of such an embodiment. FIG. 6 shows a messenger bag having a display screen 61. The display screen may be LCD, LED, CRT, plasma or any other suitable means for display. The display screen may be used to display information provided by the PMP, such as text, still pictures and motion video. The display screen may be wired to the PMP by a data cable that may connect, for example, to a docking port on the PMP and/or a video out port. For example, a single Y-shaped data cable may be used to connect a docking port on the PMP to the audio amplifier and the display screen.

The display screen may be mounted on the face of the bag or luggage. A cover flap may optionally be used to protect the display screen when not in use. This cover flap may be similar to the cover flap described above.

The display screen may include a display controller means and a display panel. The display controller means and the display panel may be housed in a single casing or may be separate. Where the display controller means and the display panel are separately housed, only the display panel need be mounted on the face of the bag or luggage. In such a case, the PMP may be connected to the display controller means, and the display controller means may be connected to the display panel.

The display screen may incorporate or be connected to a power source. This power source may be the same power source as used by the amplifier or it may be a separate power source. The power source may be any suitable means for providing power, for example, those means discussed above in reference to the amplifier power source. According to one embodiment of the present invention, the display controller means and the amplifier may be a single unit having a single power supply.

The above specific embodiments are illustrative, and many variations can be introduced on these embodiments without departing from the spirit of the disclosure or from the scope of the appended claims. For example, elements and/or features of different illustrative embodiments may be combined with each other and/or substituted for each other within the scope of this disclosure and appended claims.

What is claimed is:

1. A bag or luggage for portable media players, comprising:
an amplifier, contained within the bag or luggage, for amplifying an audio signal from a portable media player;
one or more speakers, contained within the bag or luggage and connected to the amplifier, for reproducing sound from the amplified audio signal;
an enclosure for housing the personal media player, a front portion of the enclosure comprising a soft transparent layer suitable for viewing and controlling the personal media player.

2. The bag or luggage of claim 1, wherein the bag or luggage is a folio-style case.

3. The bag or luggage of claim 1, wherein the bag or luggage is a messenger bag.

4. The bag or luggage of claim 1, wherein the speakers are mounted on the front of the bag or luggage.

5. The bag or luggage of claim 1, wherein the speakers are hidden from view on the bag or luggage beneath a porous or otherwise sound transmitting covering.

6. The bag or luggage of claim 1, wherein amplifier controls are accessible from the front of the bag or luggage.

7. The bag or luggage of claim 1 additionally comprising a retractable, removable or hinged cover over the soft transparent layer.

8. The bag or luggage of claim 7, wherein the cover may be secured in a closed poison by magnets, clips, snaps, zippers, or Velcro.

9. The bag or luggage of claim 1 additionally comprising a portable power source for powering the amplifier.

10. The bag or luggage of claim 9 wherein the portable power source comprises one or more batteries, fuel cells, solar panels, or hand cranks.

11. A bag or luggage for portable media players, comprising:
an amplifier, contained within the bag or luggage, for amplifying an audio signal from a portable media player;
one or more speakers, contained within the bag or luggage and connected to the amplifier, for reproducing sound from the amplified audio signal;
an enclosure for housing the personal media player; and
a display screen visible from an outside surface of the bag or luggage for displaying information from the portable media player.

12. The bag or luggage of claim 11, wherein the display screen comprises an LCD, LED, CRT or plasma display screen and a display controller unit.

13. The bag or luggage of claim 11, wherein the information displayed on the display screen is text, still pictures, or motion video information.

14. The bag or luggage of claim 11, wherein the bag or luggage is a folio-style case.

15. The bag or luggage of claim 11, wherein the bag or luggage is a messenger bag.

16. The bag or luggage of claim 11, wherein the speakers are mounted on the front of the bag or luggage.

17. The bag or luggage of claim 11, wherein the speakers are hidden from view on the bag or luggage beneath a porous or otherwise sound transmitting covering.

18. The bag or luggage of claim 11, wherein amplifier controls are accessible from the front of the bag or luggage.

19. The bag or luggage of claim 11 additionally comprising a retractable, removable or hinged cover over the display screen.

20. The bag or luggage of claim 19, wherein the cover may be secured in a closed poison by magnets, clips, snaps, zippers, or Velcro.

21. The bag or luggage of claim 11 additionally comprising one or more portable power sources for powering the amplifier and the display screen.

22. The bag or luggage of claim 21 wherein the portable power source comprises one or more batteries, fuel cells, solar panels, or hand cranks.

23. The bag or luggage of claim 11, additionally comprising an enclosure for housing the personal media player, a front portion of the enclosure comprising a soft transparent layer suitable for viewing and controlling the personal media player.

24. The bag or luggage of claim 23 additionally comprising a retractable, removable or hinged PMP cover over the soft transparent layer.

25. The bag or luggage of claim 24, wherein the PMP cover may be secured in a closed poison by magnets, clips, snaps, zippers, or Velcro.
